(19) United States
(12) Patent Application Publication
(10) Pub. No.: US 2026/0162686 A1
(43) Pub. Date: Jun. 11, 2026

(54) IMAGE CAPTURING APPARATUS, MOVING IMAGE COMBINING APPARATUS, METHODS OF CONTROLLING THE SAME, AND STORAGE MEDIUM

(71) Applicant: CANON KABUSHIKI KAISHA, Tokyo (JP)

(72) Inventor: TOSHIHIRO SHIBATA, Aichi (JP)

(21) Appl. No.: 19/183,224

(22) Filed: Apr. 18, 2025

(30) Foreign Application Priority Data
Apr. 24, 2024 (JP) 2024-070810

(51) Int. Cl. G11B 27/34; H04N 5/91

(52) U.S. Cl. CPC G11B 27/34; H04N 5/91

(57) ABSTRACT

An image capturing apparatus acquires a series of image capture data including a plurality of consecutive frames; and generates, in a case where the series of image capture data is to be divided into a plurality of pieces of image capture data and recorded, metadata to be added to the divided image capture data. The apparatus generates first metadata relating to the divided image capture data and second metadata relating to the combined image capture data in a case where a plurality of pieces of the divided image capture data are combined, as metadata to be added to the divided image capture data.

### BACKGROUND OF THE INVENTION

### FIELD OF THE INVENTION

The present invention relates to an image capturing apparatus, a moving image combining apparatus, methods of controlling the same, and a storage medium.

### DESCRIPTION OF THE RELATED ART

In recent years, image capturing apparatuses such as digital video cameras have become known that are capable of recording shot moving images onto a plurality of storage media such as SD cards simultaneously. By dividing the data between a plurality of storage media when recording the data, it becomes possible to record high-resolution, high-frame-rate video even in a case where a single storage medium is unable to keep up with the amount of data being written to the storage medium.

Japanese Patent Application Laid-Open No. 2004-328073 describes a technique of, in a case where a shot moving image is recorded in a divided manner, adding information indicating that the moving image data has been divided to make it possible to identify the divided moving image data.

Incidentally, when a moving image is shot, various pieces of information about the camera, lens, and image, called metadata, can be added to the image data and audio data and recorded according to the moving image format used for recording. Since the metadata of a moving image includes data relating to the moving image itself, in a case where divided moving images are combined, it is necessary to perform processing for updating the metadata relating to the combined moving image. In a case where metadata is added to each frame, the processing is required for each frame, and therefore the processing cost increases as the recording time of the divided moving image becomes longer.

### SUMMARY OF THE INVENTION

The present invention has been made in consideration of the above problems, and realizes a technology that can reduce the processing cost of adding metadata in a case where divided moving images are combined.

In order to solve the aforementioned issues, one aspect of the present disclosure provides an image capturing apparatus comprising: an acquisition unit configured to acquire a series of image capture data including a plurality of consecutive frames; and a generation unit configured to, in a case where the series of image capture data is to be divided into a plurality of pieces of image capture data and recorded, generate metadata to be added to the divided image capture data, wherein the generation unit generates first metadata relating to the divided image capture data and second metadata relating to the combined image capture data in a case where a plurality of pieces of the divided image capture data are combined, as metadata to be added to the divided image capture data.

Another aspect of the present disclosure provides a moving image combining apparatus comprising: an acquisition unit configured to acquire a plurality of pieces of divided image capture data by dividing a series of image capture data including a plurality of consecutive frames; and a generation unit configured to, in a case where the plurality of pieces of divided image capture data are to be combined, generate metadata to be added to combined image capture data based on metadata added to the divided image capture data, wherein the metadata added to the divided image capture data includes first metadata relating to the divided image capture data and second metadata relating to the combined image capture data, and the generation unit generates metadata to be added to the combined image capture data by using at least the second metadata included in the divided image capture data.

Still another aspect of the present disclosure provides a method of controlling an image capturing apparatus, the method comprising: acquiring a series of image capture data including a plurality of consecutive frames; and generating, in a case where the series of image capture data is to be divided into a plurality of pieces of image capture data and recorded, metadata to be added to the divided image capture data, wherein generating the metadata includes generating first metadata relating to the divided image capture data, and second metadata relating to the combined image capture data in a case where a plurality of pieces of the divided image capture data have been combined, as metadata to be added to the divided image capture data.

Yet another aspect of the present disclosure provides a method of controlling a moving image combining apparatus, the method comprising: acquiring a plurality of pieces of divided image capture data obtained by dividing a series of image capture data including a plurality of consecutive frames; and generating, in a case where the plurality of pieces of divided image capture data are to be combined, metadata to be added to the combined image capture data based on the metadata added to the divided image capture data, wherein the metadata added to the divided image capture data includes first metadata relating to the divided image capture data and second metadata relating to the combined image capture data, and generating the metadata includes generating metadata to be added to the combined image capture data by using at least the second metadata included in the divided image capture data.

Still yet another aspect of the present disclosure provides a non-transitory computer-readable storage medium comprising instructions for performing a method of controlling an image capturing apparatus, the method comprising: acquiring a series of image capture data including a plurality of consecutive frames; and generating, in a case where the series of image capture data is to be divided into a plurality of pieces of image capture data and recorded, metadata to be added to the divided image capture data, wherein generating the metadata includes generating first metadata relating to the divided image capture data, and second metadata relating to the combined image capture data in a case where a plurality of pieces of the divided image capture data have been combined, as metadata to be added to the divided image capture data.

Yet still another aspect of the present disclosure provides a non-transitory computer-readable storage medium comprising instructions for performing a method of controlling a moving image combining apparatus, the method comprising: acquiring a plurality of pieces of divided image capture data obtained by dividing a series of image capture data including a plurality of consecutive frames; and generating, in a case where the plurality of pieces of divided image capture data is to be combined, metadata to be added to the combined image capture data based on metadata added to the divided image capture data , wherein the metadata added to the divided image capture data includes first metadata relating to the divided image capture data and second metadata relating to the combined image capture data, and generating the metadata includes generating metadata to be added to the combined image capture data by using at least the second metadata included in the divided image capture data.

According to the present invention, it is possible to reduce the processing cost of adding metadata in a case where divided moving images are combined.

Further features of the present invention will become apparent from the following description of exemplary embodiments (with reference to the attached drawings).

### BRIEF DESCRIPTION OF THE DRAWINGS

FIG. 1 is a block diagram showing an example of a configuration of an image capturing apparatus 100 according to a first embodiment.

FIG. 2 is a block diagram showing an example of a configuration of a moving image combining apparatus 200 according to the first embodiment.

FIG. 3A is a diagram showing an example of a folder configuration in which files are recorded, according to the first embodiment.

FIG. 3B is a diagram illustrating a configuration of a RAW file according to the first embodiment.

FIG. 4 is a flowchart showing a series of operations in division recording processing according to the first embodiment.

FIG. 5A is a diagram showing an example of a folder configuration in which a file recorded in a divided manner is recorded, according to the first embodiment.

FIG. 5B is a diagram illustrating mdat of a RAW file recorded in a divided manner according to the first embodiment.

FIG. 6 is a flowchart showing a series of operations in combination processing according to the first embodiment.

FIG. 7 is a diagram illustrating mdat of a RAW file after combination, according to the first embodiment.

FIG. 8A is a diagram showing an example of a folder configuration of MXF according to a second embodiment.

FIG. 8B is a diagram illustrating a configuration of an MXF file according to the second embodiment.

FIG. 8C is a diagram illustrating a configuration of metadata in a management information file according to the second embodiment.

FIG. 9 is a flowchart showing a series of operations in divided recording processing according to the second embodiment.

FIG. 10A is a diagram showing an example of a folder configuration of MXF recorded in a divided manner in the second embodiment.

FIG. 10B is a diagram illustrating metadata of MXF and MIF recorded in a divided manner according to the second embodiment.

FIG. 11 is a flowchart showing a series of operations in combination processing according to the second embodiment.

FIG. 12 is a diagram illustrating metadata of MXF after combination, according to the second embodiment.

### DESCRIPTION OF THE EMBODIMENTS

### First Embodiment

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In the following description, an example will be described in which an image capturing apparatus capable of recording moving images is used. The image capturing apparatus according to this embodiment may be, for example, a digital camera, a smartphone, a game console, a personal computer, a tablet terminal, a surveillance camera, a medical device, or the like. An example will also be described in which a moving image combining apparatus is used, which is capable of combining moving images recorded in a divided manner. The moving image combining apparatus according to this embodiment may be, for example, a personal computer, a digital camera, a smartphone, a game console, a tablet terminal, a medical device, or the like.

### Configuration of Image Capturing Apparatus

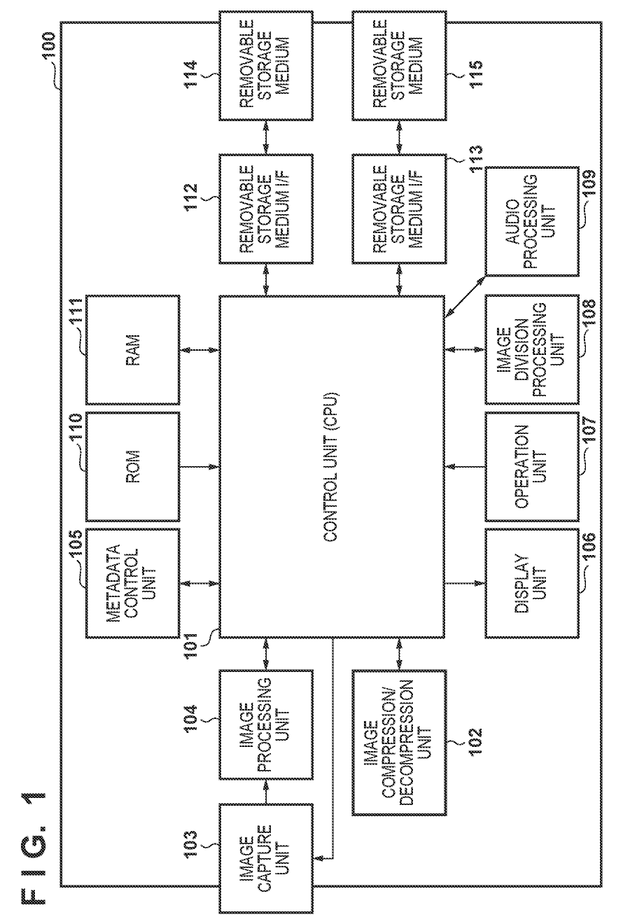

A configuration of an image capturing apparatus 100 according to this embodiment will be described with reference to FIG. 1. In this embodiment, an example will be described in which management information such as a time code and audio data are recorded in a video frame in a moving image format called RAW. However, other formats, such as MP4 (MPEG-4 Part 14 or ISO/IEC 14496-14:2003) and Material eXchange Format (MXF), can also be used as the moving image format.

In FIG. 1, a control unit 101 and each unit of the image capturing apparatus 100 can exchange data with each other. The control unit 101 is a system control unit that performs overall control of the system of the image capturing apparatus 100. The control unit 101 controls each unit of the image capturing apparatus 100 by loading a program recorded in a ROM 110 into a RAM 111 and executing the program. In addition, the control unit 101 executes processing for recording a moving image in a divided manner in a plurality of removable storage media (divided recording processing). The divided recording processing will be described later. The ROM 110 is a non-volatile storage medium, and stores programs to be executed by the control unit 101. The RAM 111 is a volatile storage medium used as a work memory for the control unit 101. In addition, the RAM 111 is used also as a RAM for temporarily storing image data captured by an image capture unit 103 and image-processed by an image processing unit 104, and image data divided by an image division processing unit 108. Furthermore, the RAM 111 is used to temporarily store image data read out from a removable storage medium 114 or a removable storage medium 115 in order for an image compression/decompression unit 102 to perform compression processing or decompression processing. Of course, the RAM 111 may also be used to temporarily store image data to be displayed on a display unit 106 and additional information to be recorded in association with a captured image.

The image capturing apparatus 100 can be equipped with a plurality of (e.g., two) storage media for recording image data. For this purpose, a removable storage medium I/F112 and a removable storage medium I/F113 are included as interfaces. The removable storage medium I/F 112 and the removable storage medium I/F113 are slots into which a removable storage medium such as a memory card can be inserted. FIG. 1 shows an example in which the removable storage medium 114 and the removable storage medium 115 are attached to the removable storage mediumI /F 112 and the removable storage medium I/F 113. In the example of this embodiment, an example is described in which the image data is recorded in the removable storage medium 114 and the removable storage medium 115, but a case is also conceivable in which the image data is recorded in a non-removable memory built into the image capturing apparatus 100. In addition, conceivable configurations include a configuration in which there are two or more removable storage medium I/Fs and removable storage media, and a configuration in which image data is recorded in one or more removable storage medium I/Fs and removable storage media and a non-removable built-in memory.

The image capture unit 103 has a shooting lens (including a zoom lens and a focus lens) and an image capture element, captures a subject under the control of the control unit 101, and acquires image data (image capture data) such as a still image or a moving image. The moving image captured by the image capture unit 103 includes a series of image data constituted by a plurality of consecutive frames.

The image processing unit 104 performs predetermined pixel interpolation, resizing processing, and color conversion processing on the image data captured by the image capture unit 103. In addition, the image processing unit 104 performs predetermined computation processing using the captured image data, and the control unit 101 performs various controls (exposure control, auto white balance control, etc.) related to image capture performed by the image capture unit 103 based on the obtained computation result.

The image compression/decompression unit 102 performs processing for compressing the image data processed by the image processing unit 104 and processing for decompressing the image data read out from the removable storage medium 114 and the removable storage medium 115.

The display unit 106 is a display for displaying various setting states, images captured by the image capture unit 103, images read out and played back from the removable storage medium 114 and the removable storage medium 115, and the like, based on the control of the control unit 101. The display unit 106 is constituted by a display inside a peering viewfinder, a vari-angle LCD monitor, and the like.

An operation unit 107 is an operation unit that receives operations from a user and includes a power switch for supplying power to the image capturing apparatus 100, a recording start button, and a mode switching button for switching between a camera mode (shooting mode) and a playback mode. Note that in a case where the operation unit 107 includes a touch panel, the control unit 101 can detect the following operations on the touch panel. The touch panel being touched with a finger or pen (hereafter referred to as a “touch-down”). A state in which the touch panel is being touched by a finger or pen (hereinafter referred to as a “touch-on”). Moving a finger or pen while touching the touch panel (hereafter referred to as a “move”). Removing a finger or pen from the touch panel that the finger or pen was touching (hereafter referred to as a “touch-up”). A state in which nothing is touching the touch panel (hereinafter referred to as a “touch-off”). These operations and the position coordinates of the touch panel where a finger or pen is touching are notified to the control unit 101, and the control unit 101 determines what operation has been performed on the touch panel based on the notified information. Regarding a move, the direction of movement of the finger or pen moving on the touch panel can be determined for each of a vertical component and horizontal component on the touch panel based on changes in the position coordinates. Also, a stroke is considered to have been drawn in a case where the user performs a touch-down on the touch panel, performs a certain move, and then performs a touch-up. The action of drawing a stroke quickly is called a flick. A flick is an operation in which a finger is moved quickly a certain distance while touching the touch panel, and then removed from the touch panel, and in other words, a flick is an operation in which a finger is quickly traced across the touch panel in a flicking motion. When a move is detected at a predetermined speed or more over a predetermined distance or more and then a touch-up is detected, it can be determined that a flick has been performed. Also, in a case where it is detected that a move has been performed a predetermined distance or more at less than a predetermined speed, it is determined that a drag has been performed. The touch panel may be of any of various types, such as a resistive film type, a capacitive type, a surface acoustic wave type, an infrared type, an electromagnetic induction type, an image recognition type, or an optical sensor type.

Under the control of the control unit 101, the image division processing unit 108 records, in a divided manner, a series of temporally consecutive pieces of image data, which are stored in the RAM 111, in a removable storage medium. The image division processing unit 108 divides frames of a series of pieces of image data into a plurality of moving images in units of a predetermined number in accordance with a specific rule, and records the divided frames in the removable storage medium. Dividing according to a specific rule includes, for example, dividing frames of a moving image into even-numbered frames and odd-numbered frames, or dividing sequentially from the first frame by the number of removable storage media and non-removable built-in memories, but there is no limitation to this example.

Under the control of the control unit 101, an audio processing unit 109 acquires audio using a microphone built into the image capturing apparatus 100 at the same time as the start of moving image recording, and temporarily stores the acquired audio data in the RAM 111. Note that in the present embodiment, a configuration in which a microphone built into the image capturing apparatus 100 is used is described as an example, but a configuration in which a microphone attached externally to the image capturing apparatus 100 is used is also conceivable.

Under the control of the control unit 101, a metadata control unit 105 generates metadata to be added to image data. In a case where image data is recorded in a divided manner in later-described divided recording processing, the metadata control unit 105 generates metadata to be added to the divided image data. In this case, the metadata control unit 105 generates first metadata relating to the image data divided by the image division processing unit 108, and second metadata relating to the combined image data in a case where a plurality of pieces of divided image data are combined. The metadata includes, for example, a time code, a frame rate, a recording time, and the like. Note that the processing for combining divided image data (combination processing) is processing for combining image data that has been recorded in a divided manner in a plurality of removable storage media (e.g., by a moving image combining apparatus 200). In a case where a plurality of pieces of divided image data are combined, some metadata relating to the combined image data may have different values (e.g., time codes) from the metadata relating to the divided image data. For this reason, in a case of combining a plurality of pieces of divided image data, it is necessary to calculate metadata to match the combined image data or change the values of the metadata relating to the image data being combined. The metadata control unit 105 provides the values of the combined metadata to the divided image data (as second metadata) at the stage of recording the captured image data in a divided manner in order to eliminate the need for calculation or modification of the values of the metadata in a case where the divided image data is combined.

In a case where a plurality of pieces of divided image data are combined, the metadata (e.g., time code) relating to the combined image data will be the same as the metadata relating to the image data before division (i.e., at the time of capture). For this reason, the metadata control unit 105 can generate metadata for the image data captured by the image capture unit 103, and can use this as the metadata for the combined image data.

The metadata generated as the metadata for the combined image data includes, in a case where a plurality of pieces of divided image data are combined, the metadata of the divided image data whose values need to be updated to relate to the combined image data, and the identification information thereof. The generated metadata also includes information about the shooting lens and camera orientation of the image capture unit 103. The metadata control unit 105 stores these pieces of metadata in the RAM 111 and reads them out. Furthermore, in response to an instruction from the image division processing unit 108 or the control unit 101, for example, the metadata control unit 105 adds (attaches) metadata to the moving image files recorded in the removable storage medium 114 and the removable storage medium 115. The metadata includes metadata that is unique to each clip and is determined at the start of recording (hereinafter referred to as “per-clip metadata”) and metadata that is determined for each frame (hereinafter referred to as “frame-synchronous metadata”).

### Configuration of Moving Image Combining Apparatus

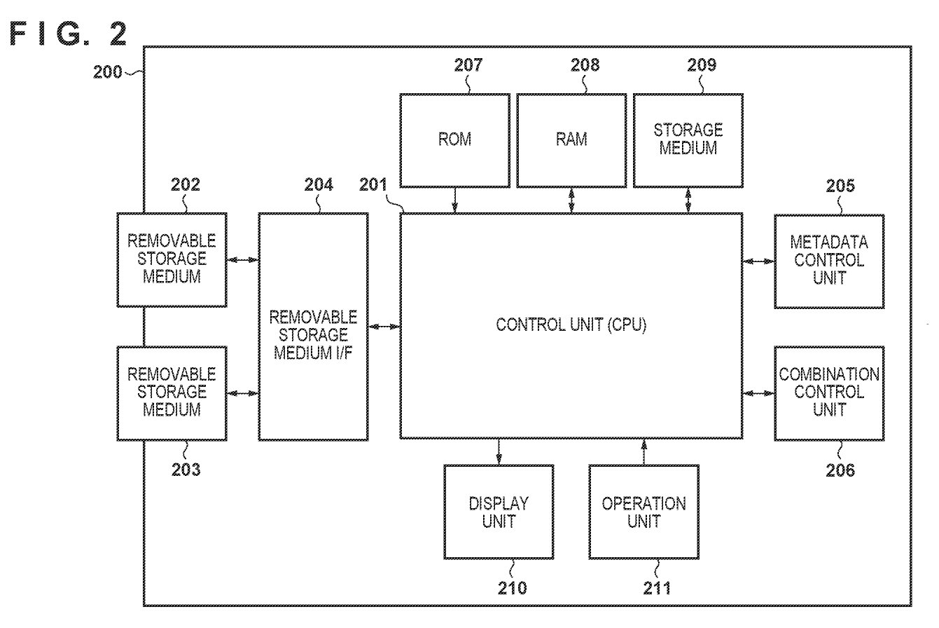

Next, a configuration of the moving image combining apparatus 200 according to this embodiment will be described with reference to FIG. 2. A control unit 201 and each unit of the moving image combining apparatus 200 can exchange data with each other.

The control unit 201 is a system control unit that performs overall control of the system of the moving image combining apparatus 200. The control unit 201 loads a program recorded in a ROM 207 into a RAM 208 and executes the program to control each unit of the moving image combining apparatus 200 and to execute combination processing, which will be described later. The ROM 207 is a non-volatile memory, and stores programs executed by the control unit 201. The RAM 208 is a volatile memory used as a work memory for the control unit 201. The RAM 208 is also used as a VRAM that temporarily stores image data input from a removable storage medium I/F 204 in order to display the image data on a display unit 210 or to combine the image data in a combination control unit 206. Furthermore, the RAM 208 is also used as a RAM for temporarily storing metadata acquired by a metadata control unit 205. A storage medium 209 is a hard disk drive (HDD) or solid state drive (SSD) that records data such as applications, moving image files, and still image files, and may be either built-in or externally attached.

The removable storage medium I/F204 is a slot into which a removable storage medium such as a memory card can be inserted. FIG. 2 shows an example in which a removable storage medium 202 and a removable storage medium 203 are attached to the removable storage medium I/F204. In the moving image combining apparatus 200, a configuration in which two removable storage media are attached to the removable storage medium I/F204 has been described as an example, but it is conceivable to use a configuration in which two or more removable storage media are attached, and to attach these simultaneously or individually.

Under the control of the control unit 201, the metadata control unit 205 temporarily stores, in the RAM 208, the metadata that has been added to the divided and recorded image data that has been read out from the removable storage medium 202 and the removable storage medium 203. As described above, the metadata added to the divided and recorded image data includes first metadata relating to the divided and recorded image data and second metadata relating to the combined image data in a case where a plurality of pieces of divided and recorded image data are combined. In addition, the metadata relating to the combined image data includes, in a case where a plurality of pieces of divided and recorded image data are combined, the metadata relating to the divided and recorded image data whose values need to be updated so as to relate to the combined image data, and the identification information thereof. The metadata control unit 205 extracts metadata whose values need to be updated at the time of combination, and the identification information thereof, from the metadata temporarily stored in the RAM 208.

The combination control unit 206 combines the divided and recorded image data that was input from the removable storage medium 202 and the removable storage medium 203 and temporarily stored in the RAM 208. Note that in order to distinguish it from image data in a moving image file, the above-mentioned divided and recorded image data is also called a divided and recorded moving image file. That is, what is described as divided and recorded image data corresponds to a divided and recorded moving image file. A moving image file contains image data, audio data, and metadata. In a case of combining the divided and recorded image data, the combination control unit 206 uses the second metadata extracted by the metadata control unit 205 to set the values of the metadata of the combined image data. In other words, in a case of combining the divided and recorded image data, the combination control unit 206 can generate metadata for the combined moving image file using the metadata (second metadata) that was added to the divided and recorded image data.

The display unit 210 includes, for example, a display. Under the control of the control unit 201, the display unit 210 displays various setting states, images read out from the removable storage medium 202 and the removable storage medium 203 and played back, and images combined by the combination control unit 206 and played back.

An operation unit 211 includes a power switch for supplying power to the moving image combining apparatus 200, and a graphical user interface (GUI) for operating menus, executing a combination operation for divided moving images, and the like.

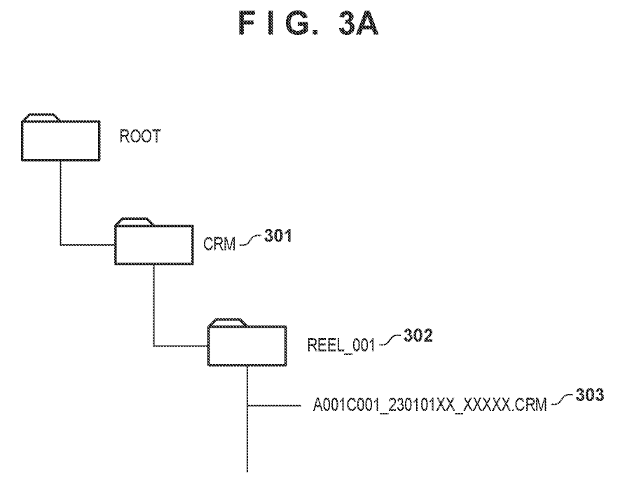

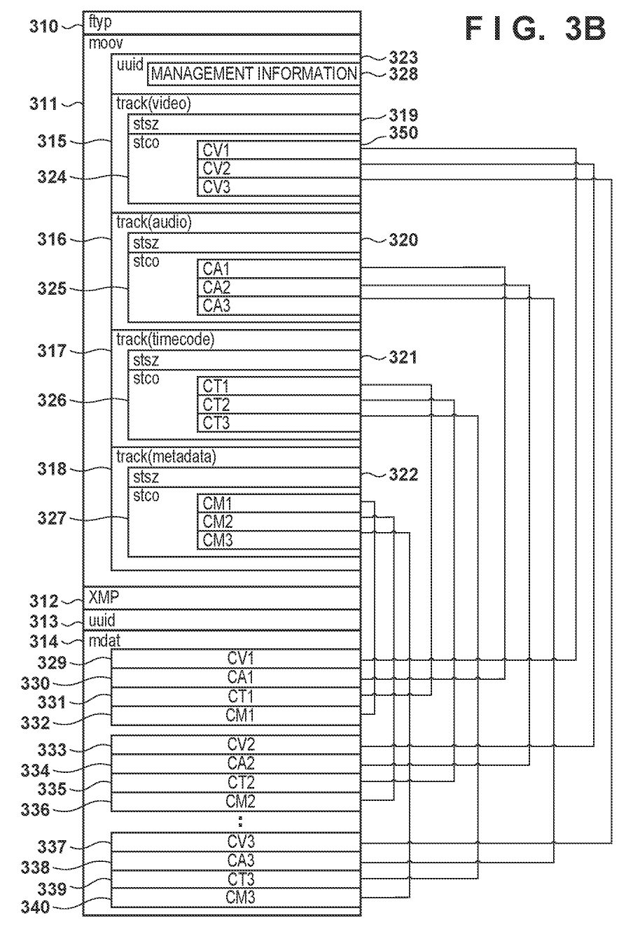

FIG. 3A shows an exemplary folder configuration in the case where the control unit 101 records a RAW file. First, when the removable storage medium 114 or the removable storage medium 115 is initialized by operating the operation unit 107, a CRM folder 301 is generated. When recording is started by the operation unit 107, for example, a “REEL_001” folder 302 is generated. Here, the “001” in the folder name represents the reel number. Furthermore, a stream file 303 with a file name, for example, “A001C001_230101XX_XXXXX.CRM” is recorded. Here, “A” in the file name indicates, for example, an identification (ID) assigned to the image capturing apparatus 100, and can be freely set in the image capturing apparatus 100 by operating the operation unit 107. “001” immediately following “A” indicates the reel number, and “C001” indicates the clip number. “230101” represents the date, and in this example, it indicates that shooting was performed on January 1, 2023. “XX” indicates a randomly-generated ID consisting of letters and numbers. “XXXXX” indicates a five-character string consisting of letters and numbers that can be freely set in the image capturing apparatus 100 using the operation unit 107. Also, as a plurality of moving image files are recorded, the file names of the RAW files change and the number of files increases.

Next, the configuration of a RAW file according to the first embodiment will be described with reference to FIG. 3B. In this embodiment, an example will be described in which a structure of an ISO base media file format is used.

Reference numeral 310 denotes an ftyp box indicating the compatibility of the file format. Reference numeral 311 denotes a moov box in which management information necessary for playback and the like is stored. Reference numeral 312 denotes a box in which the Extensible Metadata Platform (XMP) is stored, and any metadata can be set therein. Reference numeral 313 denotes a uuid box where any information can be added. Reference numeral 314 indicates an mdat box in which encoded video data, audio data, time code data, and metadata for each frame are stored.

Next, the configuration of the moov box 311 will be described. Reference numeral 323 denotes a uuid box in which any information can be added, and management information 328 used during playback and the like are stored therein. Reference numerals 315 to 318 denote track boxes, each of which is a box in which management information relating to image data, audio data, time code data, and metadata for each frame is stored. Reference numerals 319 to 322 denote stsz boxes, each of which stores the data size for each encoding unit of the image data, audio data, time code data, and metadata for each frame. Reference numerals 324 to 327 indicate stco boxes stored in the track boxes. The stco boxes store information indicating the storage locations in the mdat box 314 for the image data, audio data, time code data, and metadata for each frame. Each piece of data is stored in the mdat box 314 in units called chunks, each of which is constituted by one or more encoding units. In this embodiment, one chunk is represented as one frame, but one chunk may also be a plurality of frames.

Next, the configuration of the mdat box 314 will be described. Reference numerals 329 to 340 denote image data, audio data, time code data, and metadata for each frame, which are stored in the mdat box 314. Each piece of data can be accessed in units of chunks according to the values written in the stco boxes. For example, 329 (CV1) can be traced back to 350 in the stco box 324.

### Series of Operations in Divided Recording Processing

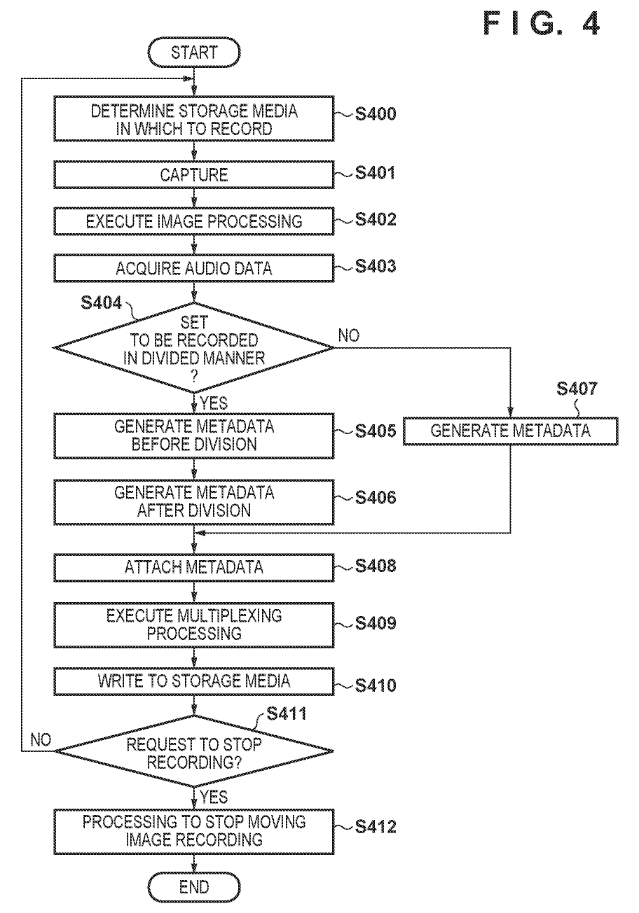

Next, a series of operations in the divided recording processing according to this embodiment (e.g., processing for recording image data in a divided manner in the removable storage medium 114 and the removable storage medium 115) will be described with reference to FIG. 4. Note that the series of operations in the divided recording processing is realized by the control unit 101 loading a program recorded in the ROM 110 into the RAM 111, executing it, and controlling each unit of the image capturing apparatus 100.

In step S400, the control unit 101 determines storage media in which to record the image data to be captured in step S401. The control unit 101 can determine the storage media in which to record the image data, for example, according to a predetermined setting. For example, the control unit 101 determines the storage media such that even-numbered frames of captured image data are recorded in the removable storage medium 114 and odd-numbered frames are recorded in the removable storage medium 115. In this embodiment, an example will be described in which even-numbered frames are recorded in the removable storage medium 114 and odd-numbered frames are recorded in the removable storage medium 115, but the recording destinations of the frames may also be switched in any order depending on the number of removable storage media and built-in memories.

In step S401, the control unit 101 executes image capture using the image capture unit 103, to acquire image data. The image data output from the image capture unit 103 is stored in the RAM 111. In step S402, the image processing unit 104 performs image processing on the image data captured in step S401. In step S403, the audio processing unit 109 acquires audio data. The audio data acquired by the audio processing unit 109 is stored in the RAM 111.

In step S404, the control unit 101 determines whether or not the image data is set to be recorded in a divided manner. The control unit 101 refers to setting information recorded in the ROM 110 or stored in the RAM 111, for example, and determines whether the image data is set to be recorded in a divided manner. If the control unit 101 determines that the image data is set to be recorded in a divided manner, the processing proceeds to step S405, and if not, the processing proceeds to step S407.

In step S405, the metadata control unit 105 generates the above-mentioned metadata relating to the image data before division (i.e., at the time of image capture) and its identification information (i.e., the metadata and its identification information after combination) and temporarily stores them in the RAM 111. For example, the metadata control unit 105 generates a time code according to the frame rate of the image data before division as metadata relating to the image data before division, and stores the generated time code in the RAM 111. As described above, the time code according to the frame rate of the image data before division can be a time code according to the frame rate of the image data after combination (in a case where the divided image data has been combined).

In step S406, the metadata control unit 105 generates metadata relating to the divided image data and temporarily stores the generated metadata in the RAM 111. For example, the metadata control unit 105 generates a time code according to the frame rate of the divided image data as metadata, and stores the generated time code in the RAM 111.

On the other hand, if the image data is not to be recorded in a divided manner, in step S407, the metadata control unit 105 generates metadata relating to the image data (in the case of not performing divided recording) and temporarily stores the generated metadata in the RAM 111.

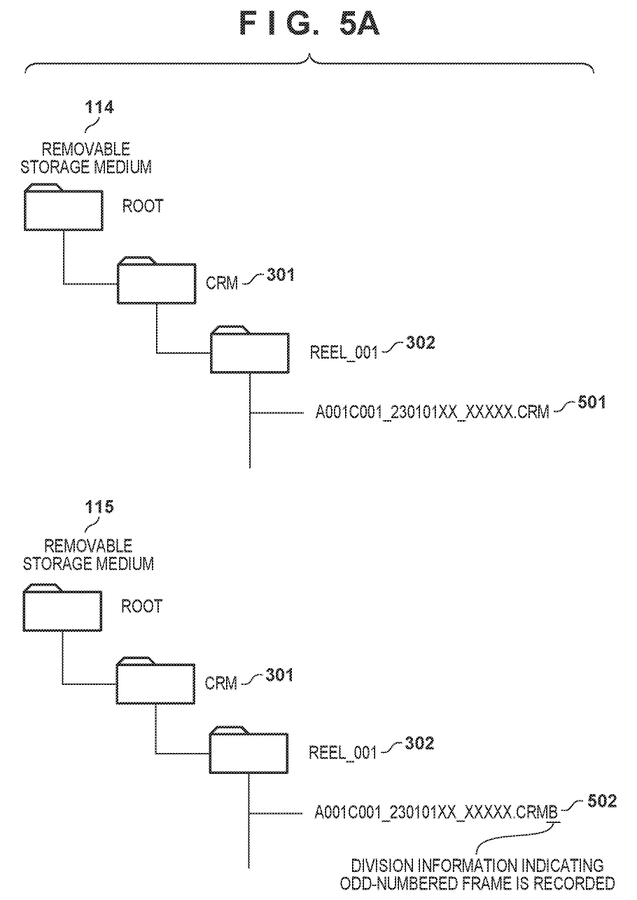

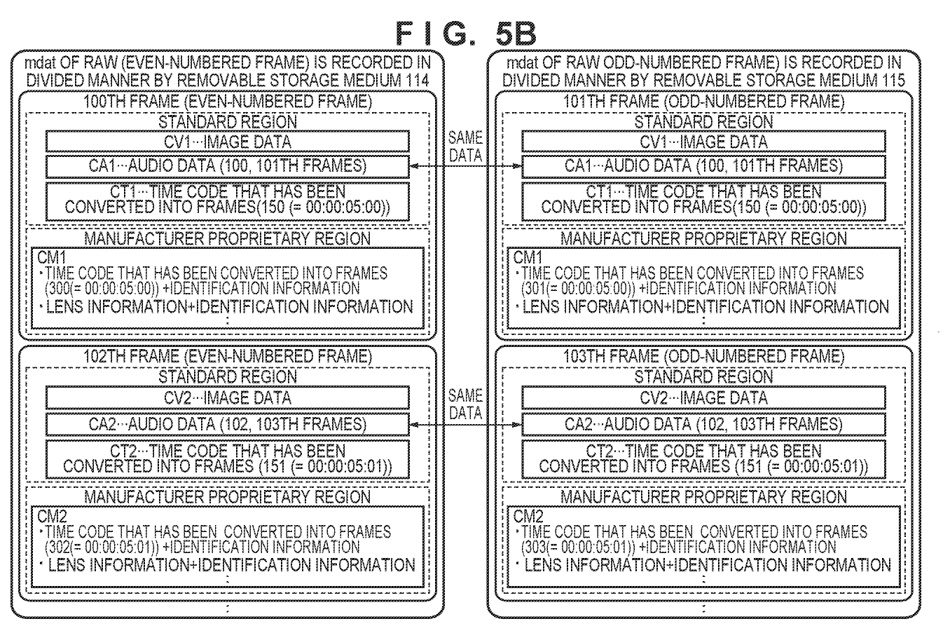

In step S408, the metadata control unit 105 adds (attaches) the metadata temporarily stored in the RAM 111 to the image data to be recorded in the removable storage media. If image data is to be recorded in a divided manner, the metadata control unit 105 adds first metadata relating to the divided image data and second metadata relating to the combined image data in the case where a plurality of pieces of divided image data have been combined, in separate regions. The regions to which the generated metadata is added will be described later with reference to FIG. 5B.

In step S409, the control unit 101 performs multiplexing processing on the image data, audio data, and metadata of the moving image data. In step S410, the control unit 101 writes the data multiplexed in S409 in the removable storage media determined in step S400. In step S411, the control unit 101 determines whether there is a request to stop recording, for example, via the operation unit 107, and if it is determined that there is a request to stop recording, the processing proceeds to step S412, and if not, the processing returns to step S400 so as to perform processing of the next frame. In step S412, the control unit 101 stops recording the captured data, and performs processing required when recording is stopped, such as footer recording. Thereafter, the control unit 101 ends the series of operations of the divided recording processing.

FIG. 5A shows a folder configuration in the case where a moving image file is recorded in a divided manner in the removable storage medium 114 and the removable storage medium 115. The folder configurations 301 and 302 in the removable storage medium 114 and the removable storage medium 115 are the same as the configuration shown in FIG. 3A. Here, a stream file 501 recorded in the removable storage medium 114 is one in which data of even-numbered frames is recorded, and a stream file 502 recorded in the removable storage medium 115 is one in which data of odd-numbered frames is recorded.

In the stream file 502, “B” is added to the end of the extension as division information for distinguishing that data of odd-numbered frames is recorded. Note that although an example has been given in which “B” is added to the end of the extension as division information indicating odd-numbered frames, there is no limitation to this example. Numbers may be used instead of letters, a combination of letters and numbers may be used, or such information may be added to the beginning of the extension. Also, the division information may indicate even-numbered frames instead of odd-numbered frames, or may indicate a specific division rule. That is, the division information may be added to either or both of the stream files 501 and 502 at any position in the file names thereof.

FIG. 5B shows an example of the configuration of an mdat box in a case of being recorded in a divided manner in the removable storage medium 114 and the removable storage medium 115 according to the first embodiment. This mdat corresponds to the mdat box 314 described above. Image data of even-numbered frames in the image data captured by the image capture unit 103, audio data acquired by the audio processing unit 109, and metadata generated by the metadata control unit 105 are recorded in the removable storage medium 114. Specifically, CV1 and CV2 denote image data captured by the image capture unit 103 as, for example, the 100th and 102nd images, in that order. CA1 denotes audio data recorded between when the 100th image data is captured and when the 102nd image data is captured. CT1 denotes a time code that is generated as metadata relating to the divided image data in step S406 shown in FIG. 4. This time code is a time code that has been converted into frames according to the frame rate of the divided image data in order to record in a standard region. Here, the standard region is a region that is predefined by an industry standard, and indicates a region that can be used with a common understanding by various companies by referring to the standard when playing back or editing a moving image. In the example shown in FIG. 5B, CT1 corresponding to the 100th and 101st frames stores “150”, which is a time code according to the frame rate of the divided image data.

On the other hand, CM1 is defined in the manufacturer proprietary region. The manufacturer proprietary region is a region that the manufacturer can define as proprietary according to a standard and is allowed to use freely, and the metadata and identification information recorded in this region do not directly influence operations in which the standard region is used. CM1 records the time code, which is the same metadata item as the standard region, and metadata (lens information, etc.) defined as proprietary to the manufacturer. For example, the time code recorded in CM1 is a time code that has been converted into frames for recording in a standard region of the combined image data, according to the frame rate of the combined image data in the case where the image data is combined. That is, the time code recorded in this CM1 is the time code of the image data before division, which is generated in step S405 in FIG. 4. In the example shown in FIG. 5B, CM1 corresponding to the 100th frame stores “300”, which is a time code according to the frame rate of the image data before division. In addition, CM1 corresponding to the 101st frame stores “301”, which is a time code according to the frame rate of the image data before division. The removable storage medium 115 records odd-numbered frames of the image data captured by the image capture unit 103, the audio data acquired by the audio processing unit 109, and the metadata generated by the metadata control unit 105. Here, regarding the audio data, the same audio data as the RAW audio data recorded in the removable storage medium 114 is recorded.

### Series of Operations in Combination Processing

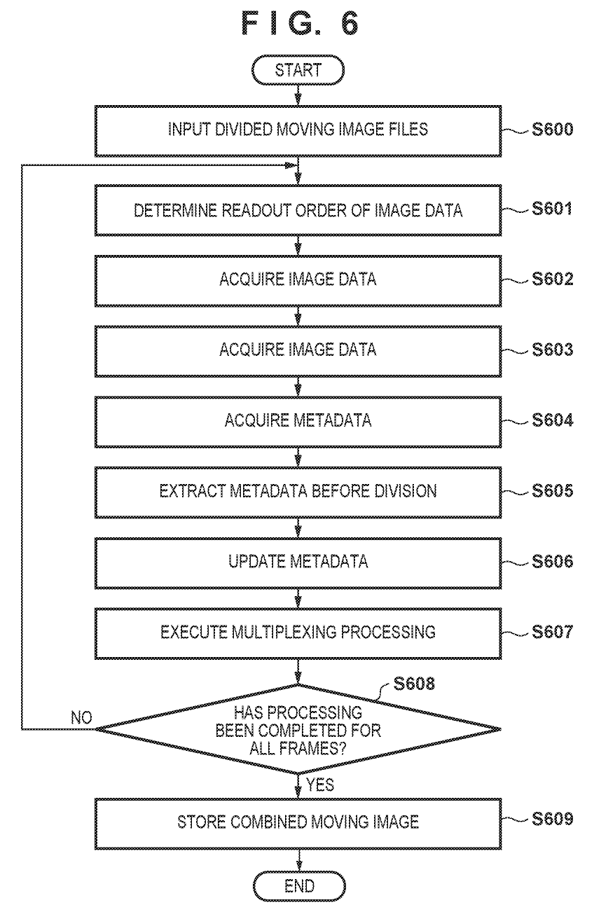

Next, a series of operations in the combination processing will be described with reference to FIG. 6. The combination processing is processing in which the moving image combining apparatus 200 combines the moving image files recorded in a divided manner in the removable storage medium 202 and the removable storage medium 203. Note that the series of operations in the combination processing is realized by the control unit 201 loading a program recorded in the ROM 207 into the RAM 208, executing the program, and controlling each unit of the moving image combining apparatus 200.

In step S600, the control unit 201 loads, into the RAM 208, moving image files that were stored in a divided manner in the removable storage medium 202 and the removable storage medium 203 connected to the removable storage medium I/F 204. Here, the divided and recorded moving image files may be recorded in the storage medium 209 and then the data thereof may be loaded into the RAM 208.

In step S601, the metadata control unit 205 determines the readout order of the image data. Specifically, the metadata control unit 205 analyzes the file names of the divided and recorded moving image files that were loaded into the RAM 208 in step S600, and determines that files with a “B” at the end of the extension are moving image files in which odd-numbered frames are recorded. In addition, the metadata control unit 205 determines that moving image files that do not have a “B” at the end of the extension are moving image files in which even-numbered frames are recorded. In addition, the metadata control unit 205 sets the data of the first frame of the moving image file in which the even-numbered frames are recorded as the data of the first frame of the combined moving image file. Similarly, the metadata control unit 205 sets the data of the first frame of the moving image file in which odd-numbered frames are recorded as data of the first frame of the odd-numbered frames of the combined moving image file. Then, the frames of the divided and recorded moving image files are alternatingly set from there up to the final frame to determine the order of the frames after combination, whereby the readout order of the frame data of the divided and recorded moving image files with respect to the frames of the combined moving image is determined.

In step S602, the combination control unit 206 acquires image data of a specific frame in a specific divided and recorded moving image file, based on the readout order of the image data determined in step S601. The combination control unit 206 temporarily stores the acquired image data in the RAM 208.

In step S603, the combination control unit 206 acquires audio data associated with the specific frame having the image data acquired in step S602. The combination control unit 206 temporarily stores the acquired audio data in the RAM 208. Note that although an example will be described here in which the acquired audio data is associated with a specific frame, the audio data may be associated with even-numbered frames or odd-numbered frames that form pairs when moving images are combined. Furthermore, in the case where a moving image file is divided into three or more files as well, the audio data to be acquired may be audio data associated with a set of frames.

In step S604, the metadata control unit 205 acquires metadata associated with the specific frame having the image data acquired in step S602. That is, in the example of the 100th frame described above in FIG. 5B, the metadata control unit 205 acquires the data of CT1 stored in the standard region and the data of CM1 stored in the manufacturer proprietary region as metadata associated with this frame. The metadata control unit 205 temporarily stores the acquired metadata in the RAM 208.

In step S605, the metadata control unit 205 extracts the metadata added to the image file after division, and the metadata whose values need to be updated when combining and the identification information thereof, from, for example, the data of CT1 and CM1 acquired in step S604.

In step S606, the combination control unit 206 identifies a metadata item of the divided image data (e.g., the time code of CT1), which is the same as the metadata item having the identification information extracted in step S605 (e.g., the time code of CM1). Then, the combination control unit 206 updates the value of the identified metadata item (e.g., the time code of CT1) with the value of the metadata that needs to be updated and that is recorded together with the identification information (e.g., the time code of CM1). The combination control unit 206 temporarily stores the updated value in the RAM 208. The configuration of the metadata of the combined image data will be described later.

In the above-mentioned example of the time code, the combination control unit 206 sets the time code in the standard region of the combined image data using the identification information and time code recorded in the manufacturer proprietary region of the divided and recorded image data. For example, the time code (e.g., 300) recorded in the manufacturer proprietary region of the frame corresponding to the 100th frame of the divided and recorded image data is set as the time code in the standard region (of the 100th frame) of the combined image data.

In step S607, the control unit 201 performs multiplexing processing on the image data, audio data, and metadata in the moving image file. In step S608, the control unit 201 determines whether the combination processing has been completed for all frames in the divided and recorded moving image file input in step S600. If the control unit 201 determines that the combination processing for all frames has been completed, the processing proceeds to step S609, and if not, the processing returns to step S602 in order to perform the processing of the next frame.

In step S609, the control unit 201 records the combined moving image in the storage medium 209. Here, the combined moving image may also be recorded in the removable storage medium 202 or the removable storage medium 203. It is also conceivable that the combined moving image is transmitted to a server on the network to which the moving image combining apparatus 200 is connected, and the combined moving image is recorded on the server side. The file name of the recorded combined moving image may also be set to match the file name of the input moving image, and it is conceivable that the file name is set by adding identification information for identifying that combination has been performed to the file name of the input moving image. Thereafter, the control unit 201 ends the series of operations of the combination processing.

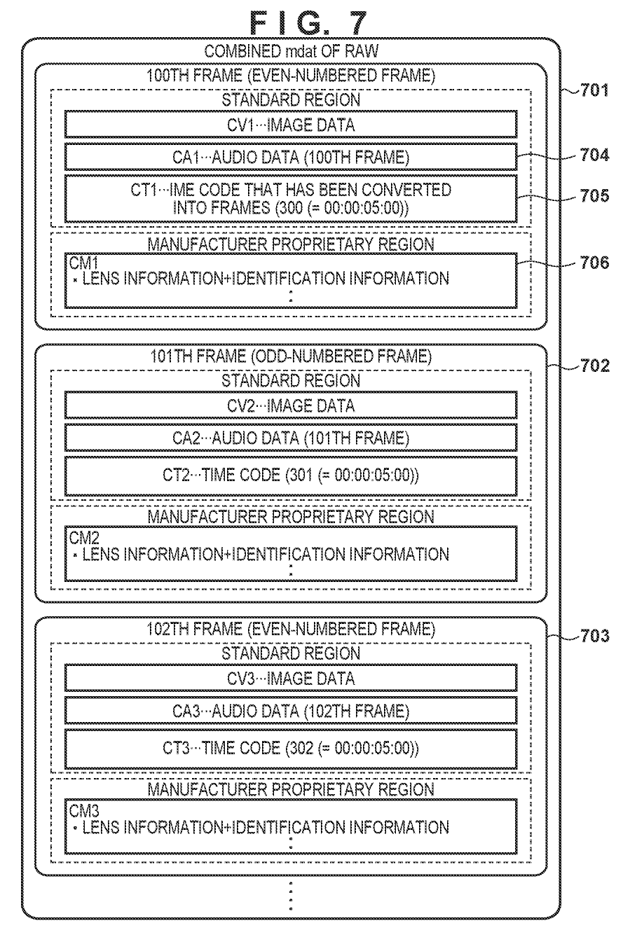

FIG. 7 shows an example of the configuration of mdat of image data combined by the moving image combining apparatus 200 according to the first embodiment. In the combined image data, as denoted by reference numerals 701 to 703, data of even-numbered frames and odd-numbered frames are recorded alternatingly (in the same manner as before division). The audio data (CA1) denoted by reference numeral 704 has an increased frame rate after combining, and therefore is shorter in time than the audio data of the divided and recorded moving image data.

The time code (CT1) in the standard region indicated by reference numeral 705 is updated to the time code recorded in the manufacturer proprietary region of the divided and recorded moving image file and then recorded. Furthermore, the metadata for each frame (CM1) in the manufacturer proprietary region denoted by reference numeral 706 records the metadata in the manufacturer proprietary region of the divided and recorded video file other than the metadata used to update values during combination and the identification information thereof (e.g., the metadata other than the time code). For example, “lens information + identification information” recorded in CM1 shown in FIG. 5B is recorded in CM1 of the reference numeral 706. In this embodiment, an example has been described in which the metadata other than the metadata used for updating the value during combination and information other than the identification information thereof are recorded in 706, but the metadata used for updating the value and the identification information thereof may also be recorded.

As described above, in this embodiment, in a case where a series of image data is divided into a plurality of pieces of image data and recorded, metadata to be added to the divided image data is generated. At this time, metadata relating to the image data after division and metadata relating to the image data after combination in a case where the plurality of pieces of divided image data are combined are generated as metadata to be added to the divided image data. At this time, data such as a time code to be recorded in the standard region of the combined image data is recorded in advance in the manufacturer proprietary region of the divided image data. By using the data recorded in the manufacturer proprietary region of the divided image data, it is possible to eliminate the need for processing for calculating and updating values in a case of combining the divided image data. That is, it is possible to reduce the processing cost of adding metadata in a case of combining divided moving images. In addition, if the metadata of the divided image data and the metadata of the combined image data are metadata that is synchronized with the frames, both pieces of metadata are generated as metadata for each frame of the divided image data. For this reason, the greater the number of frames is, the greater the effect of reducing the processing cost is.

### Second Embodiment

In the first embodiment, the divided recording processing of the RAW file and the combination processing thereof were described. In contrast to this, in the second embodiment, an example will be described in which divided recording processing and combination processing are performed for MXF and update processing is performed for metadata recorded in MIF attached to MXF. Note that in this embodiment, although the divided recording processing and the combination processing are partially different, the image capturing apparatus 100 and the moving image combining apparatus 200 described with reference to FIGS. 1 and 2 can have the same or substantially the same configuration. Accordingly, the same or substantially the same configurations are denoted by the same reference numerals and description thereof will be omitted.

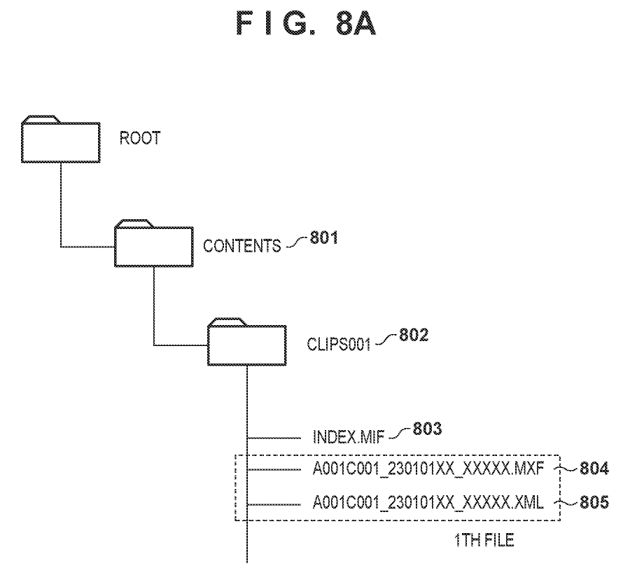

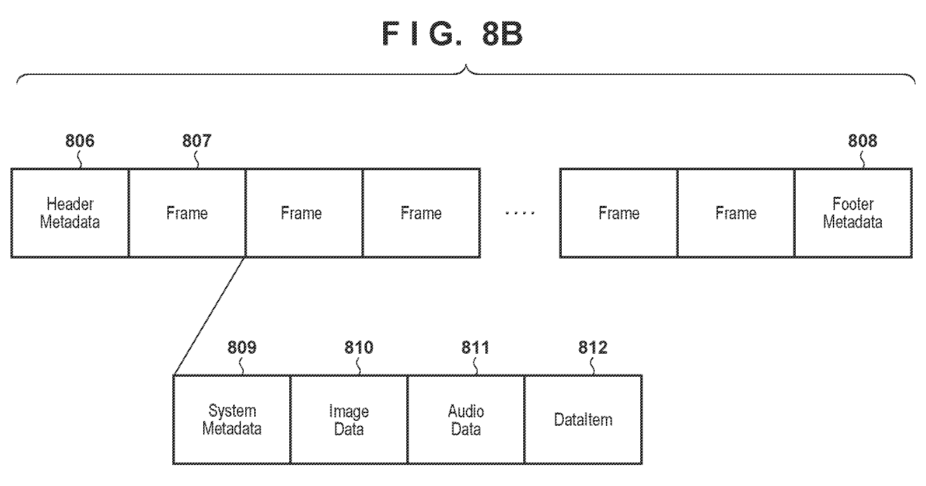

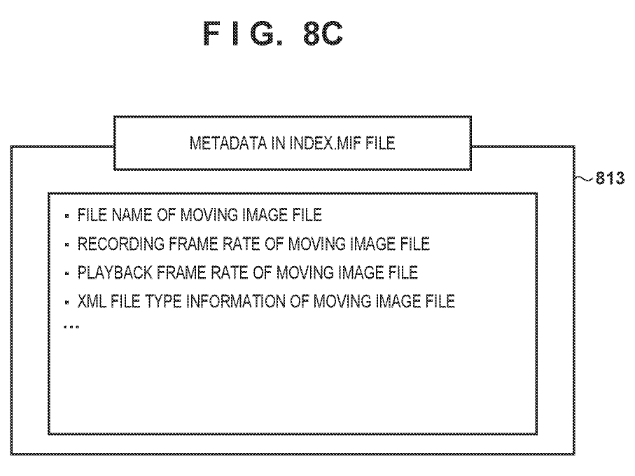

FIG. 8A shows a folder configuration in a case where the control unit 101 records an MXF file in the second embodiment. First, when the removable storage medium 114 or the removable storage medium 115 is initialized by operating the operation unit 107, a CONTENTS folder 801 and a CLIPS001 folder 802 is generated. When recording is started by operating the operation unit 107, an MIF file 803 called “INDEX.MIF” is generated. Furthermore, an MXF file 804 and an XML file 805, which are stream files, are recorded.

The file name of the MXF file 804 is, for example, “A001C001_230101XX_XXXXX.MXF”, and the file name of the XML file 805 is, for example, “A001C001_230101XX_XXXXX.XML”. The naming rules for the file names of the MXF file and XML file are the same as those for the CRM file name in the first embodiment. As a plurality of moving image files are recorded, the file names of the MXF files and XML files change and the number of files increases.

The MIF file 803 (“INDEX.MIF”) is a management file that compiles moving image file information of MXF files and XML files. By having the MIF file 803 “INDEX.MIF”, even in a case where the number of moving image files increases, it is sufficient to analyze one management file, and there is no need to analyze the inside of the folder for each moving image. For this reason, by using the MIF file 803, the analysis time can be reduced. In addition, information such as a time code that needs to be set for each frame is recorded in the MXF file 804, and tag information and the like is recorded in the XML file 805. The XML file 805 is an Extensible Markup Language (XML) file, XML being a markup language.

Next, the container structure of MXF will be described with reference to FIG. 8B. The container structure of MXF includes a header 806, frame information 807, and a footer 808. The header 806 indicates the start of the file and stores metadata information about the file. Metadata information about a file includes information such as resolution and frame rate.

The frame information 807 stores data for each frame. The frame information 807 is constituted by a SystemItem 809, image data 810, audio data 811, and a DataItem 812. The SystemItem 809 stores frame-period metadata including metadata relating to the image data 810, the audio data 811, and the DataItem 812. The DataItem 812 also stores metadata for each frame, including metadata whose values are updated for each frame, such as a time code and lens information. The footer 808 is information indicating the end of the file. The frame numbers are recorded in the SystemItem 809 region, with the starting frame being 0.

FIG. 8C shows the configuration of the MIF file 803, which is a management file. Reference numeral 813 indicates an example of the contents of metadata stored in the MIF file 803. The metadata content 813 stored in the MIF file 803 (i.e., the management file) includes the file names of the moving image file, the recording frame rates, the playback frame rates, type information of the XML file, and the like.

### Sequence of Operations in Divided Recording Processing

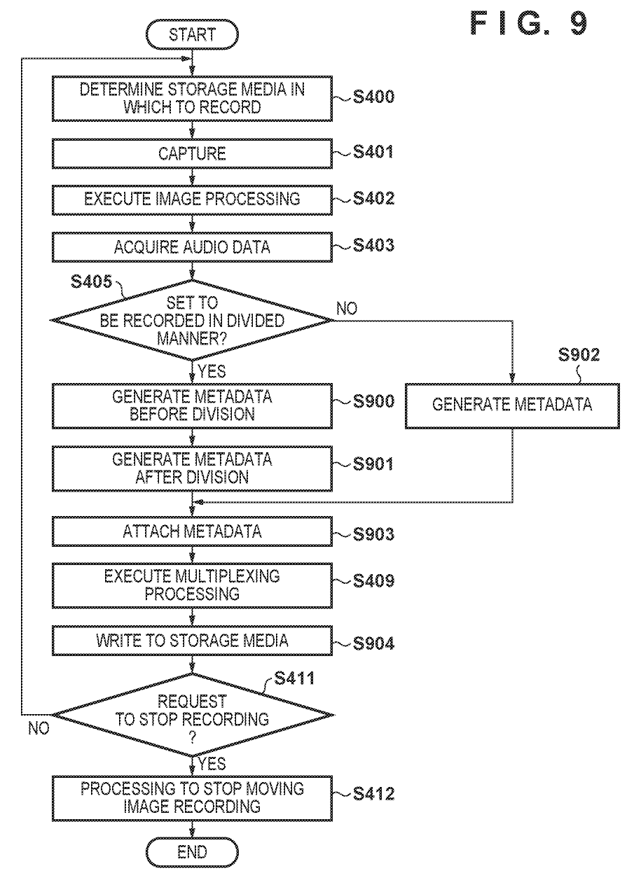

Next, a series of operations in the divided recording processing according to the second embodiment will be described with reference to FIG. 9. The divided recording processing according to the second embodiment is processing for dividing MXF image data and recording it in the removable storage medium 114 and the removable storage medium 115. Note that the series of operations in the divided recording processing is realized by the control unit 101 loading a program recorded in the ROM 110 into the RAM 111, executing the program, and controlling each unit of the image capturing apparatus 100.

In this embodiment, an example will be described in which metadata for each clip in MXF and metadata in the MIF file 803 whose values need to be updated when combined are handled, but a configuration in which XML data is handled is also conceivable. Also, similarly to the method described above in the first embodiment, a configuration is conceivable in which metadata (time codes, etc.) associated with frames whose values need to be updated during combining is recorded in a manufacturer proprietary region for each frame of MXF.

First, the processing from step S400 to step S405 is executed in the same manner as in the first embodiment. In step S900, the metadata control unit 105 generates the above-mentioned metadata relating to the image data before division (i.e., at the time of image capture) and the identification information thereof (i.e., the metadata after combination and the identification information thereof). For example, the metadata control unit 105 generates metadata and identification information whose values need to be updated at a later time of combination, and metadata and identification information relating to the MIF file 803. The metadata control unit 105 temporarily stores the generated metadata and the like in the RAM 111. The metadata whose values need to be changed at a later time of combination includes, for example, the recording frame rate and the playback frame rate, and such metadata can be stored in a manufacturer proprietary region. For example, the metadata control unit 105 generates a playback frame rate of the image data before division as metadata relating to the image data before division, and stores the generated playback frame rate in the RAM 111. As described above, the playback frame rate of image data before division can be the playback frame rate of image data after combination (in a case where the divided image data has been combined). Note that since these pieces of metadata are not synchronized with the frames, the metadata control unit 105 can generate these pieces of metadata as metadata not for each frame of the divided image capture data.

In step S901, the metadata control unit 105 generates metadata relating to the MIF file 803 of the divided image data, and temporarily stores the generated metadata in the RAM 111. On the other hand, if divided recording is not performed, in step S902, the metadata control unit 105 generates metadata relating to the image data (in the case where divided recording is not performed) and the MIF file 803, and temporarily stores the generated metadata in the RAM 111.

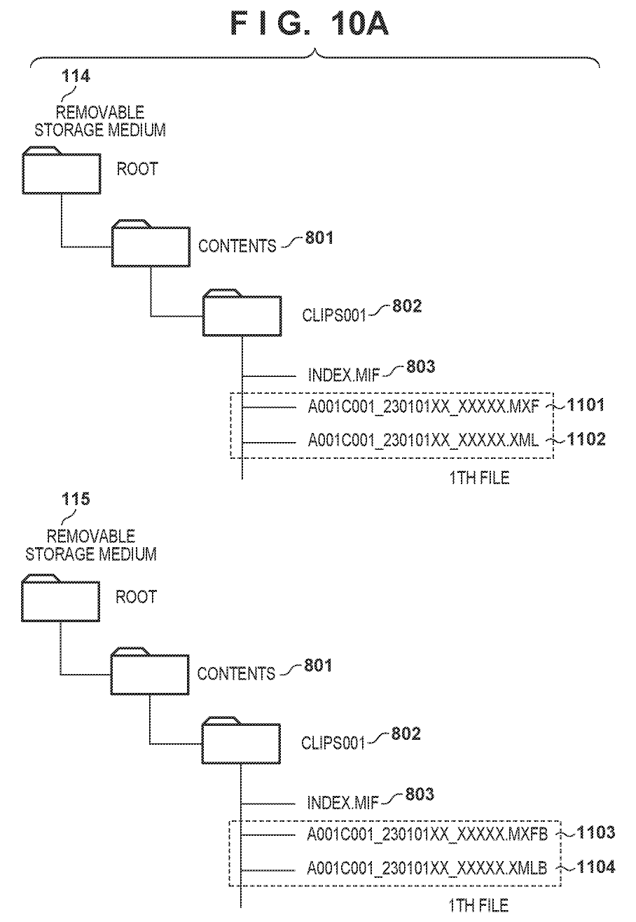

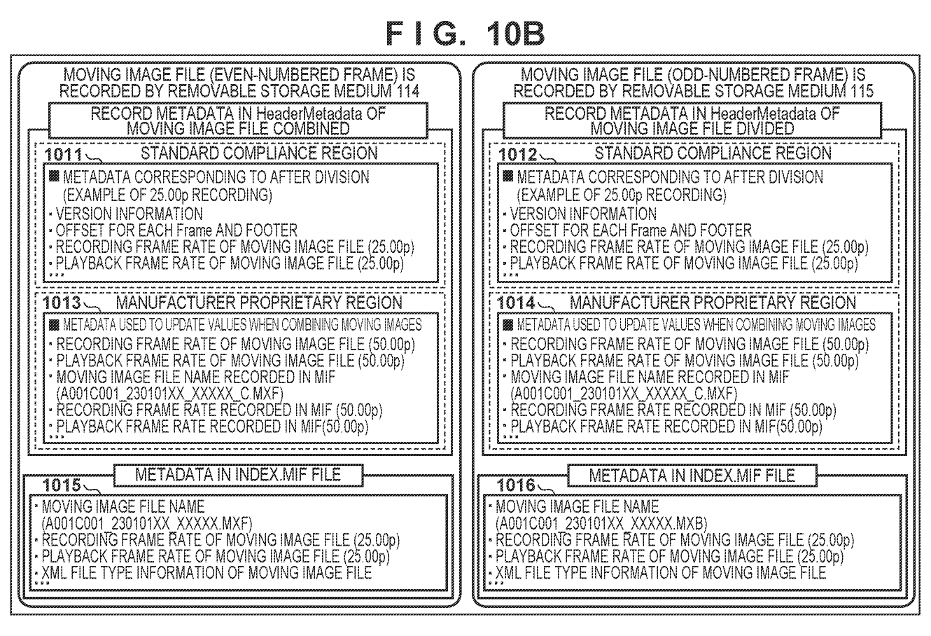

In step S903, the metadata control unit 105 adds (attaches) the metadata temporarily stored in the RAM 111 to the image data of the moving image and the MIF file 803 to be recorded in the storage medium determined in step S400. If divided recording is performed, the metadata control unit 105 attaches the metadata temporarily stored in the RAM 111 to the image data of the moving image and the MIF file 803 to be recorded in the removable storage medium. In this example as well, if image data is recorded in a divided manner, the metadata control unit 105 adds first metadata relating to the divided image data and second metadata relating to the combined image data in the case of combining a plurality of pieces of divided image data, to separate regions. The regions to which the generated metadata is added will be described later with reference to FIG. 10B. Thereafter, in step S409, the control unit 101 executes the multiplexing processing in the same manner as in the first embodiment.

In step S904, the control unit 101 writes the data multiplexed in S409 to the removable storage medium determined in step S400. In addition, the control unit 101 writes the metadata attached to the MIF file 803 in step S903.

Thereafter, the control unit 101 performs the processing of steps S410 and S411 in the same manner as in the first embodiment, and then ends the series of operations for the divided recording processing.

FIG. 10A shows the folder configuration of MXF in a case where a moving image file is recorded in a divided manner in the removable storage medium 114 and the removable storage medium 115. The MXF folder configurations 801 to 803 of the removable storage medium 114 and the removable storage medium 115 are the same as the configuration shown in FIG. 8A. Here, the MXF file 1001 and the XML file 1002 recorded in the removable storage medium 114 are files in which data of even-numbered frames is recorded. The MXF file 1003 and the XML file 1004 recorded in the removable storage medium 115 are data of odd-numbered frames. The MXF file 1003 and the XML file 1004 have “B” added to the end of their extensions as division information distinguishing that they are files in which data of odd-numbered frames is recorded. Note that although an example has been given in which “B” is added to the end of the extension as division information indicating odd-numbered frames, there is no limitation to this example. Numbers may be used instead of letters, a combination of letters and numbers may be used, or such information may be added to the beginning of the extension. Also, the division information may indicate even-numbered frames instead of odd-numbered frames, or may indicate a particular division rule. That is, the division information may be added to either one or both of the stream files 1001 and 1002 and the stream files 1003 and 1004 at any position in the file name.

FIG. 10B shows an example of the configuration of the header 806 and the MIF in the MXF file recorded in a divided manner in the removable storage medium 114 and the removable storage medium 115 according to the second embodiment. The header 806 includes a standard region and a manufacturer proprietary region.

Various types of metadata recorded in the standard regions 1011 and 1012 in the header 806 are metadata relating to the divided image data, which is recorded in the header of the MXF file recorded in each removable storage medium. On the other hand, the metadata recorded in manufacturer proprietary regions 1013 and 1014 includes metadata relating to the image data after combination, that is, metadata whose values need to be updated at the time of combination. These pieces of metadata are recorded together with the identification information. For example, the “_C” in the moving image file names recorded in 1013 and 1014 is identification information indicating that the moving image files are combined. Note that the moving image combining apparatus 200 may determine the file name of the moving image to be combined based on this identification information, or the file name may be determined by the user via the operation unit 211. Here, the metadata and identification information recorded in the manufacturer proprietary region do not directly influence the playback of MXF. Various types of metadata recorded in an MIF file 1015 and an MIF file 1016 include management information of the MXF recorded in a divided manner in each removable storage medium. For example, the recorded metadata may include, for example, the moving image file name, frame rate, and XML file type information. The moving image file name and frame rate are metadata whose values need to be updated during combination (to indicate the values after combination). On the other hand, the XML file type information is metadata that does not need to be updated.

### Series of Operations in Combination Processing

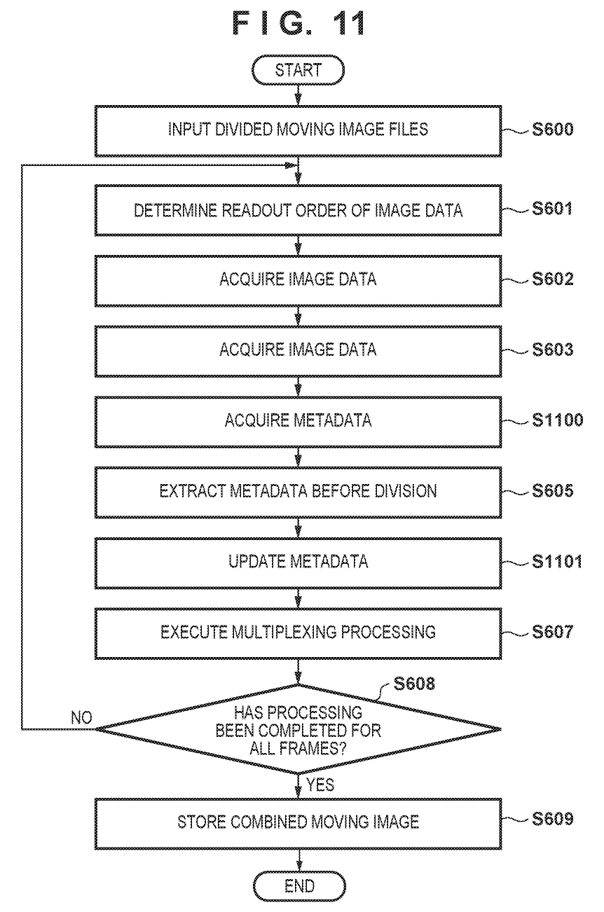

Next, a series of operations in the combination processing according to the second embodiment will be described with reference to FIG. 11. The combination processing according to the second embodiment is processing in which the moving image combining apparatus 200 combines the MXF files recorded in a divided manner in the removable storage medium 202 and the removable storage medium 203. Note that the series of operations in the combination processing is realized by the control unit 201 loading a program recorded in the ROM 207 into the RAM 208, executing the program, and controlling each unit of the moving image combining apparatus 200.

First, the processing from step S600 to step S603 is executed in the same manner as in the first embodiment. Next, in step S1100, the combination control unit 206 acquires metadata associated with the image data to be read out and related MIF and XML metadata based on the readout order of the image data determined in step S601.

In step S1101, the metadata control unit 205 extracts, from the metadata acquired in step S1100, metadata relating to the divided image data, metadata relating to the combined image data (metadata whose values need to be updated), and the identification information thereof. Thereafter, the combination control unit 206 executes the processing of step 607 to perform the multiplexing processing.

In step S1102, the combination control unit 206 identifies the divided image data and the metadata items recorded in the related MIF and XML that are equivalent to the metadata items (e.g., recording frame rate) having the identification information extracted in step S1101. Then, the combination control unit 206 updates the value of the identified metadata item (e.g., recording frame rate) with the value of the metadata whose recorded value needs to be updated. The combination control unit 206 temporarily stores the updated value in the RAM 208. The configuration of the metadata of the combined image data will be described later. In this example of the recording frame rate, the combination control unit 206 sets the recording frame rate of the standard region of the combined image data using the recording frame rate recorded in the manufacturer proprietary region of the divided and recorded image data shown in FIG. 10B. Also, in the example shown in FIG. 10B, the file name of the moving image file in the MIF file can be set (updated) using the moving image file name in the manufacturer proprietary region of the metadata relating to the image data recorded in a divided manner. However, there is no limitation to this, and the user may use the operation unit 211 to determine the name of the MXF file to be combined, and update the file using that file name. In addition, although the present embodiment has been described taking MIF as an example, a similar configuration is conceivable for other files such as XML as well.

Thereafter, the control unit 201 executes the processing of steps S608 and S609 in the same manner as in the first embodiment, and then ends the series of operations in the combination processing.

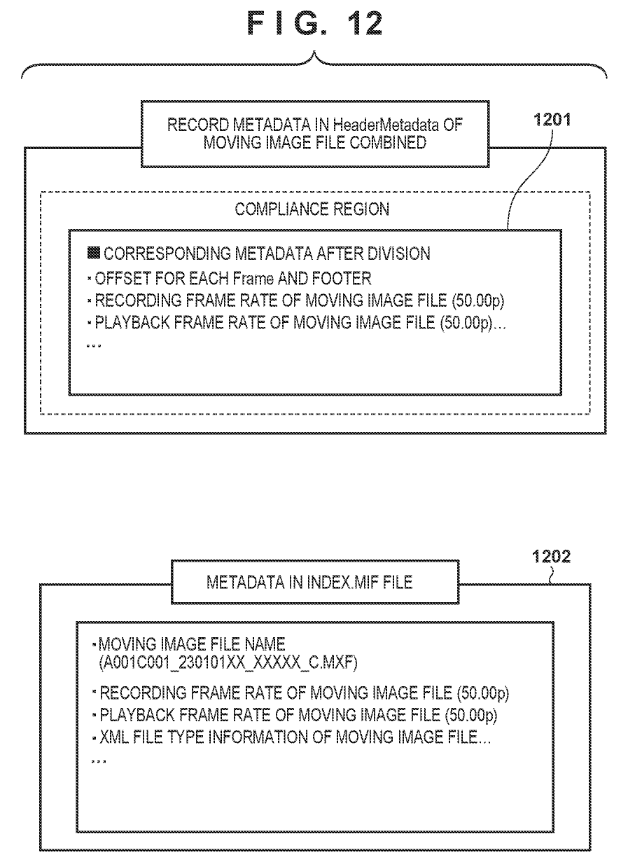

FIG. 12 is a schematic diagram showing metadata of MXF and MIF files relating to the combined image data generated through the combination processing according to the second embodiment. For example, the recording frame rate recorded in the standard region 1201 in the MXF header 806 is set (updated) using the frame rate and the identification information thereof recorded in the manufacturer proprietary region 1013 or 1014 in the MXF of the divided image data. On the other hand, information that is not recorded in the manufacturer proprietary region 1013 or 1014, such as version information (not shown), is not updated. That is, the value of the metadata (in the standard region) relating to the divided image data is recorded. Similarly, the metadata 1202 recorded in the MIF file, such as the frame rate that can be set using the data recorded in the manufacturer proprietary region 1013 or 1014 of the divided image data, is set (updated) using that data. On the other hand, XML file type information and the like is not updated.

As described above, in this embodiment, in a case where an MFX moving image file is divided into a plurality of pieces of image data and recorded, metadata to be added to the divided image data is generated. At this time, metadata relating to the divided image data and metadata relating to the combined image data in the case of combining a plurality of pieces of divided image data are generated as metadata to be added to the divided image data. At this time, data such as the frame rate to be recorded in the standard region of the combined image data is recorded in advance in a manufacturer proprietary region included in the header of the divided MXF. By using the data recorded in the manufacturer proprietary region of the divided image data in this manner, it is possible to eliminate the need to calculate and update values in a case of combining the divided image data. That is, it is possible to reduce the processing cost of adding metadata in a case of combining divided moving images. In addition, if the metadata of the divided image data and the metadata of the combined image data are not synchronized with the frames, both pieces of metadata can be generated as metadata not for each frame of the divided image data.

The present invention also encompasses a case where a software program for realizing the functions of the above-described embodiments is supplied to a system or device having a computer capable of executing the program directly from a storage medium or via wired/wireless communication, and the program is executed.

Accordingly, the program code itself that is supplied to and installed in a computer to realize the functional processing of the present invention with the computer also realizes the present invention. That is, the computer program itself for realizing the functional processing of the present invention is also included in the present invention. In this case, the form of the program, such as the object code, the program to be executed by an interpreter, or script data supplied to the OS is not important, as long as the functions of the program are included. The storage medium for supplying the program may be, for example, a hard disk, a magnetic storage medium such as a magnetic tape, an optical/magneto-optical storage medium, or a non-volatile semiconductor memory. As a method of supplying the program, a method is also conceivable in which the computer program forming the present invention is stored in a server on a computer network, and a connected client computer downloads and programs the computer program.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-070810, filed April 24, 2024 which is hereby incorporated by reference herein in its entirety.

What is claimed is:

1. An image capturing apparatus comprising:
an acquisition unit configured to acquire a series of image capture data including a plurality of consecutive frames; and
a generation unit configured to, in a case where the series of image capture data is to be divided into a plurality of pieces of image capture data and recorded, generate metadata to be added to the divided image capture data,
wherein the generation unit generates first metadata relating to the divided image capture data and second metadata relating to the combined image capture data in a case where a plurality of pieces of the divided image capture data are combined, as metadata to be added to the divided image capture data.

2. The image capturing apparatus of claim 1,
wherein the second metadata is metadata of the first metadata that needs to be updated so as to relate to the combined image capture data in a case where the plurality of pieces of divided image capture data have been combined.

3. The image capturing apparatus of claim 1,
wherein in a case where the first metadata and the second metadata are metadata synchronized with a frame, the generation unit generates the first metadata and the second metadata as metadata for each frame of the divided image capture data.

4. The image capturing apparatus of claim 1,
wherein in a case where the first metadata and the second metadata are metadata that are not synchronized with a frame, the generation unit generates the first metadata and the second metadata as metadata not for each frame of the divided image capture data.

5. The image capturing apparatus of claim 1,
wherein the second metadata is metadata to be stored in a first region that can be defined as proprietary among regions in which metadata is to be stored.

6. The image capturing apparatus of claim 5,
wherein the first metadata is metadata to be stored in a second region that is different from the first region and in which data predefined by a standard is to be stored.

7. The image capturing apparatus of claim 1,
wherein the second metadata includes a time code that is determined based on a frame rate at which each frame of the series of image capture data is acquired.

8. The image capturing apparatus of claim 1,
further comprising a division unit configured to divide the series of image capture data into a plurality of pieces of image capture data,
wherein the division unit divides the series of image capture data by dividing each predetermined number of frames of the series of image capture data into a plurality of pieces of image capture data.

9. The image capturing apparatus of claim 8, further comprising
an audio acquisition unit configured to acquire audio,
wherein the division unit divides the series of image capture data such that each piece of the divided image capture data includes identical audio data over the predetermined number of frames.

10. The image capturing apparatus of claim 1, further comprising
a recording unit configured to record each piece of the divided image capture data in a different storage medium among a plurality of storage media.

11. A moving image combining apparatus comprising:
an acquisition unit configured to acquire a plurality of pieces of divided image capture data by dividing a series of image capture data including a plurality of consecutive frames; and
a generation unit configured to, in a case where the plurality of pieces of divided image capture data are to be combined, generate metadata to be added to combined image capture data based on metadata added to the divided image capture data,
wherein the metadata added to the divided image capture data includes first metadata relating to the divided image capture data and second metadata relating to the combined image capture data, and
the generation unit generates metadata to be added to the combined image capture data by using at least the second metadata included in the divided image capture data.

12. The moving image combining apparatus of claim 11,
wherein the second metadata is metadata of the first metadata that needs to be updated so as to relate to the combined image capture data in a case where the plurality of pieces of divided image capture data have been combined.

13. The moving image combining apparatus of claim 11,
wherein in a case where the first metadata and the second metadata are metadata synchronized with a frame, the generation unit generates the second metadata as metadata for each frame of the combined image capture data.

14. A method of controlling an image capturing apparatus, the method comprising:
acquiring a series of image capture data including a plurality of consecutive frames; and
generating, in a case where the series of image capture data is to be divided into a plurality of pieces of image capture data and recorded, metadata to be added to the divided image capture data,
wherein generating the metadata includes generating first metadata relating to the divided image capture data, and second metadata relating to the combined image capture data in a case where a plurality of pieces of the divided image capture data have been combined, as metadata to be added to the divided image capture data.

15. A method of controlling a moving image combining apparatus, the method comprising:
acquiring a plurality of pieces of divided image capture data obtained by dividing a series of image capture data including a plurality of consecutive frames; and
generating, in a case where the plurality of pieces of divided image capture data are to be combined, metadata to be added to the combined image capture data based on the metadata added to the divided image capture data,
wherein the metadata added to the divided image capture data includes first metadata relating to the divided image capture data and second metadata relating to the combined image capture data, and
generating the metadata includes generating metadata to be added to the combined image capture data by using at least the second metadata included in the divided image capture data.

16. A non-transitory computer-readable storage medium comprising instructions for performing a method of controlling an image capturing apparatus, the method comprising:
acquiring a series of image capture data including a plurality of consecutive frames; and
generating, in a case where the series of image capture data is to be divided into a plurality of pieces of image capture data and recorded, metadata to be added to the divided image capture data,
wherein generating the metadata includes generating first metadata relating to the divided image capture data, and second metadata relating to the combined image capture data in a case where a plurality of pieces of the divided image capture data have been combined, as metadata to be added to the divided image capture data.

17. A non-transitory computer-readable storage medium comprising instructions for performing a method of controlling a moving image combining apparatus, the method comprising:
acquiring a plurality of pieces of divided image capture data obtained by dividing a series of image capture data including a plurality of consecutive frames; and
generating, in a case where the plurality of pieces of divided image capture data is to be combined, metadata to be added to the combined image capture data based on metadata added to the divided image capture data ,
wherein the metadata added to the divided image capture data includes first metadata relating to the divided image capture data and second metadata relating to the combined image capture data, and
generating the metadata includes generating metadata to be added to the combined image capture data by using at least the second metadata included in the divided image capture data.
